(19) United States
(12) Patent Application Publication
(10) Pub. No.: US 2011/0096034 A1
(43) Pub. Date: Apr. 28, 2011

(54) OPTICAL TOUCH-SENSING DISPLAY

(75) Inventor: Yen-Lang Huang, Hsinchu County (TW)

(73) Assignee: SONIX TECHNOLOGY CO., LTD., Hsinchu (TW)

(21) Appl. No.: 12/909,828

(22) Filed: Oct. 22, 2010

(30) Foreign Application Priority Data
Oct. 23, 2009 (TW) 98135962
Dec. 31, 2009 (TW) 98146653
Jan. 26, 2010 (TW) 99102093
May 20, 2010 (TW) 99116100

(51) Int. Cl. G06F 3/042

(52) U.S. Cl. 345/175

(57) ABSTRACT

An optical touch-sensing display including a display device, at least three light guides, at least two optical touch-sensing devices and a transmission interface is provided. The display device has a display surface and a sensing space upon the display surface. Each of the light guides disposed at periphery of the display surface has two light incident surfaces and a light-emitting surface there between. Each of the optical touch-sensing devices disposed outside of the display surface includes a sensing module and a light source. When an object enters the sensing space, each sensing module senses a light variation induced by the object to generate a first signal, and then the first signals are transmitted to one sensing module and processed to a second signal, and then the second signal is output from the optical touch-sensing device through the transmission interface.

### CROSS-REFERENCE TO RELATED APPLICATION

This application claims the priority benefits of Taiwan application serial no. 98135962, filed on Oct. 23, 2009, Taiwan application serial no. 98146653, filed on Dec. 31, 2009, Taiwan application serial no. 99102093, filed on Jan. 26, 2010 and Taiwan application serial no. 99116100, filed on May 20, 2010. The entirety of each of the above-mentioned patent application is hereby incorporated by reference herein and made a part of this specification.

### BACKGROUND

1. Field of the Invention

The invention relates to a touch-sensing display. Particularly, the invention relates to an optical touch-sensing display.

2. Description of Related Art

In recent years, with continuous progress of image display technique, since a touch screen has an advantage of conducting input directly through a touch operation, it has become a commonly used display device in the market, and is widely applied in various electronic produces such as an automatic teller machine, a terminal of a sales point, a tourist guide system, or an industrial control system, etc. A touch interface can be implemented by multiple approaches according to a conventional technique. For example, in some conventional liquid crystal displays (LCDs), a touch film can be attached on a LCD panel thereof to achieve a capacitive or a resistive touch effect.

There is another technique to achieve the touch effect by using optical sensors. The optical sensors sense a finger or a stylus on the screen, and then transmit the signals into a supplemented controller to being processed. This way will cause the increasing of cost because of setting a supplemented device including the controller on the screen or a supplemented operating platform connected to the screen.

### SUMMARY OF THE INVENTION

The invention is directed to an optical touch-sensing display, in which light guides are used to produce an optical environment with a good quality.

The invention is directed to an optical touch-sensing display, in which a universal serial bus (USB) is used to transmit a coordinate signal.

The invention is directed to an optical touch module, which has integrated touch units.

The invention is directed to an optical touch-sensing display, in which touch units and a transmission interface are integrated to achieve a better touch performance.

An embodiment of the invention provides an optical touch-sensing display including a display device, at least three light guides, at least two optical touch-sensing devices, and a transmission interface electrically connected to the optical touch-sensing devices. The display device has a display surface and a sensing space upon the display surface. The light guides are disposed at periphery of the display surface, and each of the light guides has two light incident surfaces opposite to each other and a light-emitting surface there between. The optical touch-sensing devices disposed on the display device and located outside of the display surface are electrically connected to each other. Each of the optical touch-sensing devices includes a sensing module and at least one light source. The light source emits light to the sensing space passing through the light incident surface and light-emitting surface of the light guide. When at least one object enters the sensing space, each of the sensing modules senses a light variation induced by the object in the sensing space to generate a first signal, and the first signals are transmitted to one of the sensing modules and are processed to a second signal, and then the second signal is output from the optical touch-sensing device through the transmission interface.

An embodiment of the invention provides an optical touch-sensing display including a display device, at least three sensing modules, four light guides, a plurality of light sources and a universal serial bus (USB). The display device has a display surface and a sensing space upon the display surface, wherein the display surface has a pair of long sides opposite to each other and a pair of short sides opposite to each other. The sensing modules disposed at adjacent corners of the display surface are electrically connected to each other. The light guides are respectively disposed at the long sides and the short sides. Each of the light guides has two light incident surfaces opposite to each other and a light-emitting surface there between, wherein the light-emitting surface faces to the sensing space. Each of the light sources emits light to the sensing space passing through the light incident surface and the light-emitting surface of the light guide. The USB is electrically connected to the sensing modules. When at least one object enters the sensing space, each of the sensing modules senses a light variation induced by the object in the sensing space to generate a first signal, and the first signals are transmitted to one of the sensing modules and are processed to a second signal, and then the second signal is output from the sensing module through the USB.

An embodiment of the invention provides an optical touch-sensing display including a display device, at least three light guides, at least two sensors, at least two light sources and a transmission interface. The display device has a display surface and a sensing space upon the display surface. The light guides are disposed at periphery of the sensing space. Each of the light guides has two ends opposite to each other, a light incident surface located at one end, and a light-emitting surface located between the two ends and facing to the sensing space. The sensors electrically connected to each other are respectively disposed at two adjacent corners of the display surface. Each of the light sources emits light to the sensing space passing through the light incident surface and the light-emitting surface of the light guide. The transmission interface is electrically connected to the sensors. Each of the sensors captures an image of at least one object in the sensing space to generate a signal, and then the signal are transmitted to an operating platform through the transmission interface.

An embodiment of the invention provides an optical touch module adapted to a display device to enable a touch function of the display device. The display device has a display surface and a sensing space upon the display surface. The optical touch module includes a first optical touch-sensing device, a second optical touch-sensing device, an interface circuit and a transmission interface. The first optical touch-sensing device is disposed on the display device and located at a corner of the display surface, and the second optical touch-sensing device is disposed on the display device and located at another corner of the display surface. The first optical touch-sensing device and the second optical touch-sensing device are electrically connected via the interface circuit. The transmission interface is electrically connected to at least one of the first optical touch-sensing device and the second optical touch-sensing device. When at least one object enters the sensing space, the first optical touch-sensing device and the second optical touch-sensing device sense the object and respectively generate a one-dimensional coordinate signal. The one-dimensional coordinate signals are transmitted to one of the first optical touch-sensing device and the second optical touch-sensing device, and are processed to a two-dimensional coordinate signal. Then the two-dimensional coordinate signal is output from the optical touch module through the transmission interface.

An embodiment of the invention provides an optical touch-sensing display including a display device, a first optical touch-sensing device, at least one second optical touch-sensing device and a transmission interface. The display device has a display surface and a sensing space upon the display surface. The first optical touch-sensing device includes a first system chipset and a storage device. The second optical touch-sensing device includes a second system chipset electrically connected to the first system chipset. The transmission interface is electrically connected to the first optical touch-sensing device. When at least one object enters the sensing space, the first optical touch-sensing device and the second optical touch-sensing device sense the object and respectively generate a one-dimensional coordinate signal. The one-dimensional coordinate signals are transmitted to the storage device, and are processed to a two-dimensional coordinate signal by the first system chipset, and then the two-dimensional coordinate signal is output from the first optical touch-sensing device through the transmission interface.

An embodiment of the invention provides an optical touch-sensing display including a display device, a webcam and at least two optical touch-sensing devices. The display device has a display surface and a sensing space upon the display surface. The webcam is disposed on the display device and located outside of the display surface, and includes a first storage device and a USB electrically connected to the first storage device. The optical touch-sensing devices are disposed on the display device and located outside of the display surface and are electrically connected to the webcam. Each of the optical touch-sensing devices includes a system chipset and a second storage device electrically connected to the system chipset. When at least one object enters the sensing space, the optical touch-sensing devices sense the object and respectively generate a first signal. The first signals are transmitted to one of the first storage device and the second storage devices, and are processed to a second signal, and then the second signal is output from the webcam through the USB.

According to the above descriptions, in the optical touch-sensing display of the invention, the light guides are disposed at peripheral of the display surface, so that the light emitted by the light sources may have an good light-emitting quality when being transmitted to the sensing space through the light guides, so that an optical environment of the sensing space and a touch performance of the optical touch-sensing display are improved.

Moreover, in the optical touch-sensing display of the invention, by using the sensing modules electrically connected to each other and the USB connected thereto, the first signals generated by the sensing modules are transmitted to one of the sensing modules and are processed to the second signal, and then the second signal is output from the sensing module through the USB. In this way, a data transmission amount is reduced due to a pre-computation, so that a data transmission time is shortened, and the optical touch-sensing device become more efficient.

Moreover, the optical touch module in the optical touch-sensing display is divided into a plurality of optical touch-sensing devices, and the one-dimensional coordinate signals generated by the optical touch-sensing devices are transmitted to one of the optical touch-sensing device having the storage device and are processed to a two-dimensional coordinate signal, and then the two-dimensional coordinate signal is output from the optical touch module through the transmission interface. In this way, the related system chipsets in the optical touch-sensing devices are integrated, so as to improve operating efficiencies of the optical touch module and the optical touch-sensing display.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an optical touch-sensing display according to an embodiment of the invention.

FIG. 2 is a partial three-dimensional view of the optical touch-sensing display of FIG. 1.

FIG. 3 is a component block diagram of the optical touch-sensing display of FIG. 1.

FIG. 4 is a block diagram illustrating an optical touch-sensing display according to another embodiment of the invention.

FIG. 5 is a block diagram illustrating an optical touch-sensing device in an optical touch-sensing display according to still another embodiment of the invention.

FIG. 6 is a block diagram illustrating an optical touch module according to still another embodiment of the invention.

FIG. 7 is a block diagram illustrating an optical touch-sensing display according to another embodiment of the invention.

### DETAILED DESCRIPTION OF DISCLOSED EMBODIMENTS

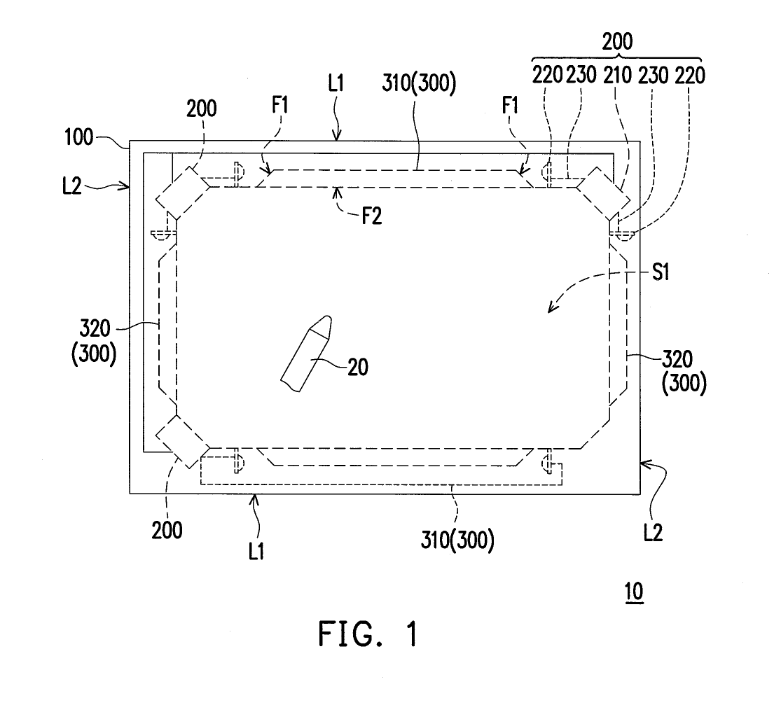

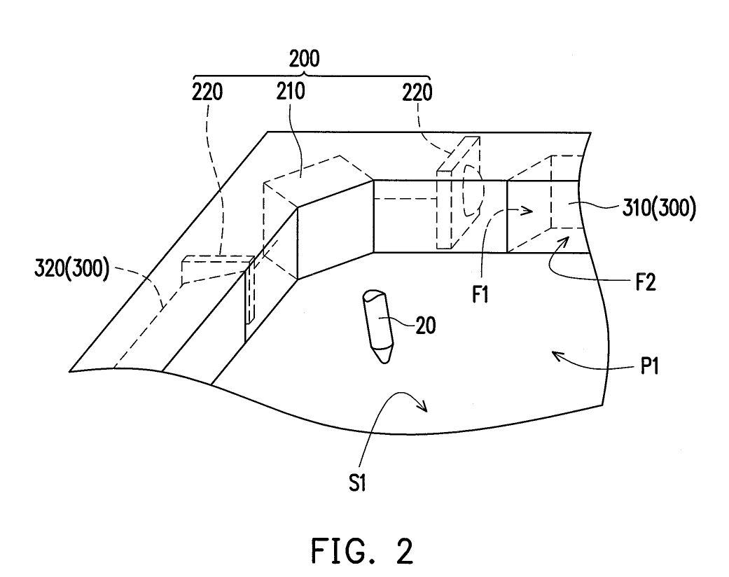

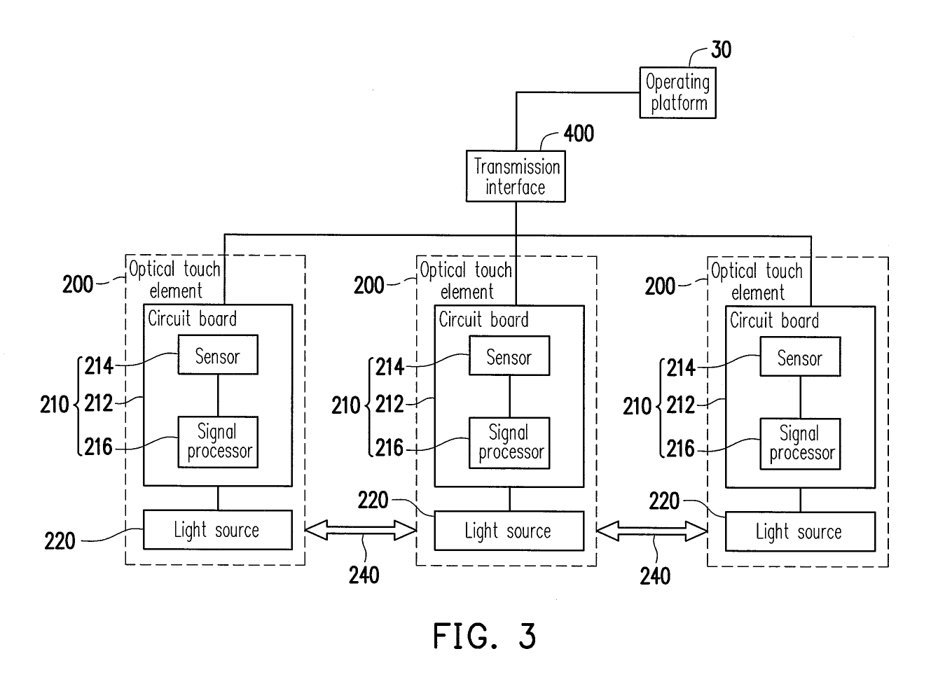

FIG. 1 is a schematic diagram illustrating an optical touch-sensing display according to an embodiment of the invention. FIG. 2 is a partial three-dimensional view of the optical touch-sensing display of FIG. 1. FIG. 3 is a component block diagram of the optical touch-sensing display of FIG. 1. Referring to FIG. 1 to FIG. 3, in the present embodiment, the optical touch-sensing display 10 includes a display device 100, three optical touch-sensing devices 200, fourth light guides 300 and a transmission interface 400. In the present embodiment, the display device 100 is a liquid crystal display (LCD), and the transmission interface 400 is a universal serial bus (USB), though the invention is not limited thereto, and in another embodiment that is not illustrated, the display device can be any electronic device having a display function, and the transmission interface can also be any related human interface device (HID).

In FIG. 1 and FIG. 2, to clearly illustrate configuration relations of various components, a part of the components of the optical touch-sensing display 10 is illustrated by dotted lines. Referring to FIG. 1 and FIG. 2, the display device 100 has a quadrilateral display surface S1 and a sensing space P1 upon the display surface S1. The light guides 300 are disposed at peripheral of the display surface S1, and each of the light guides 300 has two light incident surfaces F1 opposite to each other and a light-emitting surface F2 connected between the two light incident surfaces F1 (only one of the light guides 300 is marked for representation). Each of the optical touch-sensing devices 200 includes a sensing module 210 and a plurality of light sources 220. The light sources 220 are disposed on the display device 100 and outside of the light incident surfaces F1 of the light guides 300, and the light sources 220 emit light to the sensing space P1 through the light incident surfaces F1 and the light-emitting surfaces F2 of the light guides 300.

Moreover, in the present embodiment, the light source 220 is, for example, a light source of an invisible light such as infrared, etc. The light produced by the light sources 220 is transmitted to the sensing space P1 through the light guides 300, and based on such planar light source with a uniform brightness, the light transmitted to the sensing space P1 can form a light field with a uniform brightness in the sensing space P1.

Moreover, the optical touch-sensing display 10 of the present embodiment may also include a plurality of reflection sheets or reflection films, which can be used to surround the light guide 300 while exposing the light-emitting surface F2 of the light guide 300. In this way, the light entering the light guide 300 through the light incident surface F1 can be reflected to the light-emitting surface F2 by the reflection sheet or the reflection film, so as to increase a intensity of the light at the light-emitting surface F2. Moreover, a reflection film can also be plated on a surface of the light guide 300 other than the light incident surface and the light-emitting surface, or a microstructure (which is, for example, notches formed on the surface of the light guide that are used for increasing a light-emitting area or a light scattering area) is formed on the light guide 300, so as to increase the intensity of the light at the light-emitting surface to achieve a same effect as that described above.

In the present embodiment, each of the optical touch-sensing device 200 includes two light sources 220, though the invention is not limited thereto, and in other embodiments that are not illustrated, the optical touch-sensing device may not include the light source, or may include a plurality of the light sources, which can be varied according to an actual design requirement of the optical touch-sensing display.

In detail, the light guides 300 can be designed according to a profile of the display device 100. For example, in the display device 100 of the present embodiment, the quadrilateral display surface S1 has a pair of long sides L1 opposite to each other and a pair of short sides L2 opposite to each other. Each of the long sides L1 is located between the pair of short sides L2, and each of the short sides L2 is located between the pair of long sides L1, so that the light guides 300 of the present embodiment include first units 310 extended along the long sides L1 and second units 320 extended along the short sides L2, wherein a length of the first unit 310 is greater than that of the second unit 320.

On the other hand, the optical touch-sensing device 200 further includes conductive wires 230, wherein the light sources 220 and the sensing module 210 are electrically connected via the conductive wires 230, so that the light sources 220 and the sensing module 210 may have a same power source, and the optical touch-sensing device 200 can simultaneously control the light sources 220 and the sensing module 210 for turning on/off in collaboration, so as to achieve the effect of touch-sensing. It's not limited of the number of the light source by the present embodiment, which can be varied with a profile of the light guide 300, a number and positions of the light guides 300 disposed on the display surface S1. For example, referring to FIG. 1, since the length of the first unit 310 is longer than that of the second unit 320, in the present embodiment, the light source 220 is disposed next to each of the two light incident surfaces F1 of the first unit 310, so as to maintain a light-emitting performance thereof. Comparatively, since the length of the second unit 320 is relatively short, the same light-emitting performance as that of the first unit 310 can be achieved by disposing the light source 220 next to only one of the light incident surfaces F1 of the second unit 320. In this way, a length of the conductive wire 230 can be adjusted to modify a distance between the light source 220 and the sensing module 210, so as to correspondingly uniform the brightness of the sensing space P1. Here, the profile, the length and configuration of the light sources of the light guide 300 can be suitably varied according to an actual design requirement.

Referring to FIG. 1 and FIG. 3, in the present embodiment, each of the sensing module 210 includes a circuit board 212, a sensor 214 and a signal processor 216, wherein the sensor 214 and the signal processor 216 are electrically connected and are mounted on the circuit board 212 (the mounting technology, for example, is surface-mount technology, SMT, that the signal processor 216, the sensor 214 and the circuit board 212 are electrically connected to each other). The sensor 214 is used for sensing a light variation of the sensing space P1 to generate a sensing signal, and the signal processor 216 receives the sensing signal and determines a position of an object 20 relative to the display surface S1 to generate a first signal. When at least one object 20 (only one object is illustrated in FIG. 1, though the invention is not limited thereto) enters the sensing space P1, each of the sensing modules 210 senses a light variation induced by the object 20 in the sensing space P1 to generate the first signal. The first signals generated by the sensing modules 210 are transmitted to one of the sensing modules 210, and are processed to a second signal, and then the second signal is output from the optical touch-sensing device 200 through the transmission interface 400.

In the present embodiment, a system on chip (SoC) technique can be used to integrate the sensor 214 and the signal processor 216 into a single chip mounted on the circuit board 212 (for example, the mounting technology is the same as described above), wherein a sensing surface of the sensor 214 faces to the sensing space P1. Moreover, in another embodiment that is not illustrated, the sensor 214 and the signal processor 216 can also be fabricated into a single system in package (SiP) or a single SoC, so as to increase a signal processing speed. Here, an integration method of the sensor 214 and the signal processor 216 is not limited by the invention.

Moreover, in other embodiments that are not illustrated, the circuit board can be a flexible circuit board, and based on a bendable feature thereof, the sensor, the signal processor and the light sources can all be mounted on the flexible circuit board (for example, the mounting technology is the same as described above), so as to achieve a same effect as that described in the above embodiment.

In the present embodiment, the optical touch-sensing devices 200 are connected to each other via a serial peripheral interface (SPI) circuit 240, so as to synchronize serial data of the optical touch-sensing devices 200. When the at least one object 20 enters the sensing space P1, the sensor 214 senses light reflected by the object 20, and the object 20 is imaged on the sensor 214 as a bright dot or a dark dot. Now, the sensor 214 generates the sensing signal and transmits it to the signal processor 216. The signal processor 216 determines the position of the object 20 according to the light variation sensed by the corresponding sensor 214, and generates a one-dimensional coordinate signal. Here, the one-dimensional coordinate signal may represent an incident angle of the light reflected by the object 20 when the light enters the sensor 214.

In this way, the one-dimensional coordinate signals respectively generated by the three optical touch-sensing devices 200 are transmitted into the signal processor 216 of one of the sensing modules 210 through the SPI circuit 240, and a compiler program stored in the sensing module 210 is used to determine the position of the object 20 relative to the display surface S1 according to the one-dimensional coordinate signals. For example, the compiler program stored in the sensing module 210 calculates the position of the object 20 relative to the display surface S1 according to two incident angles of the light incident to the sensors 214, and accordingly generates a two-dimensional coordinate signal. Then, the two-dimensional coordinate signal is transmitted to an operating platform 30 through the transmission interface 400 (which is a USB in the present embodiment). In this way, the platform 30 can determine the position of the object 20 relative to an image displayed by the display surface S1, so as to implement the function of touch-sensing.

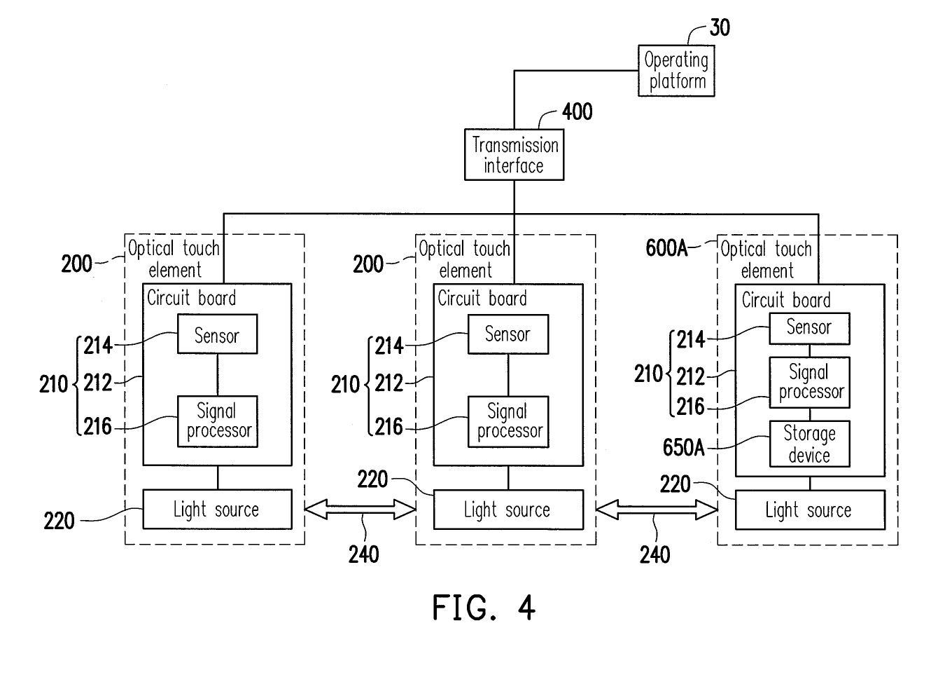

The one-dimensional coordinate signals are not limited to be collected into a specific optical touch-sensing device 200. In the present embodiment, the three optical touch-sensing devices 200 can be defined in relative relations of master and slave. FIG. 4 is a block diagram illustrating an optical touch-sensing display according to another embodiment of the invention. Referring to FIG. 4, different from the aforementioned embodiment, besides the aforementioned optical touch-sensing devices 200, the optical touch-sensing display of the present embodiment further includes an optical touch-sensing device 600A inbuilt with a storage device 650A. The storage device 650A is not only used for defining the optical touch-sensing device 600A as a master touch element (the other optical touch-sensing devices 200 are correspondingly defined as slave touch elements), but also used for processing the one-dimensional coordinate signals to a two-dimensional signal through a firmware therein after the one-dimensional coordinate signals respectively generated by the optical touch-sensing devices 200 and 600A are transmitted to the optical touch-sensing device 600A. Here, the storage device 650A, the sensor 214, and the signal processor 216 are fabricated on a single SoC, so as to increase the signal processing speed. Moreover, the storage device 650A can also be a one time programming (OTP) device.

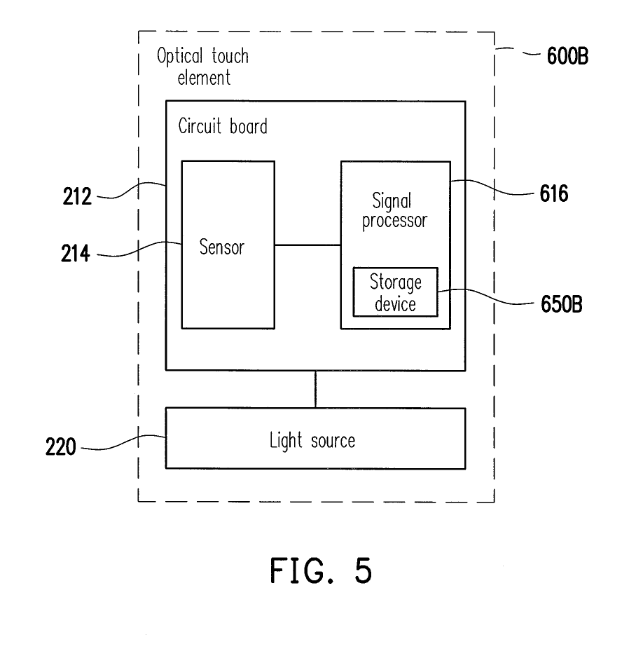

In addition, FIG. 5 is a block diagram illustrating an optical touch-sensing device in an optical touch-sensing display according to still another embodiment of the invention, in which only an optical touch-sensing device 600B serving as the master touch element is illustrated. Referring to FIG. 5, in the optical touch-sensing device 600B of the present embodiment, a signal processor 616 is an integrated circuit (IC), and a storage device 650B is a static random access memory (SRAM) in the IC.

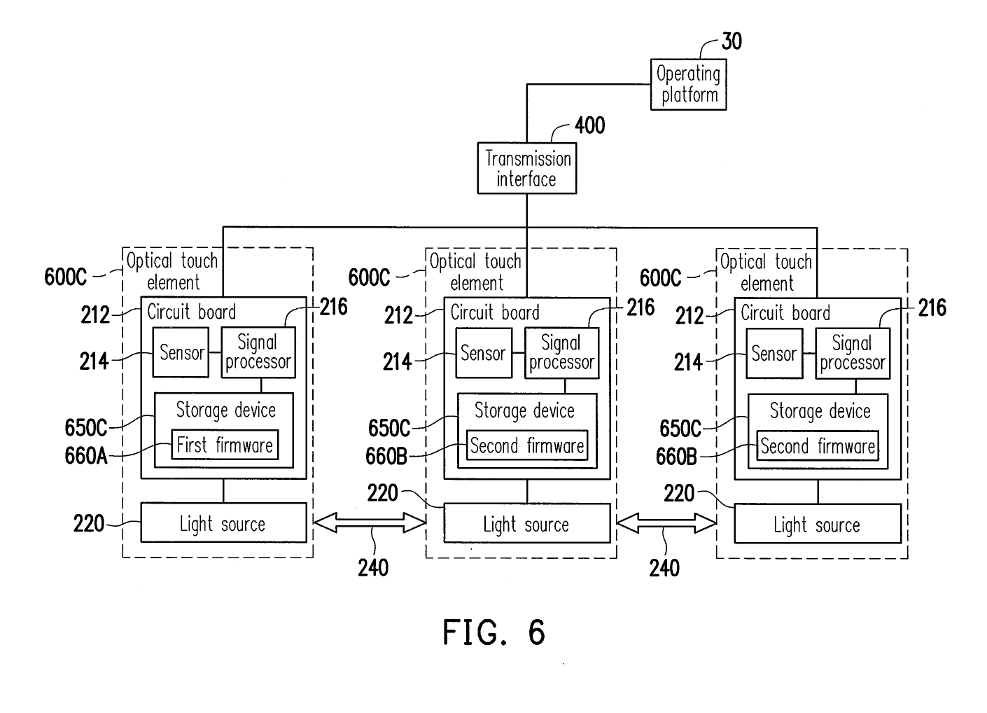

FIG. 6 is a block diagram illustrating an optical touch module according to still another embodiment of the invention. Referring to FIG. 6, different from the above embodiments, in the present embodiment, each of optical touch-sensing devices 600C includes a storage device 650C, and the master and slave touch elements are defined according to differences of the firmware stored in the storage devices 650C. For example, one of the storage device 650C stores a first firmware 660A, and the other storages devices 650C store a second firmware 660B. When the object 20 (shown in FIG. 1) enters the sensing space P1 (shown in FIG. 1), the optical touch-sensing devices 600C respectively sense a light variation in the sensing space P1 and respectively generate a one-dimensional coordinate signal by the first firmware 660A and the second firmware 660B. Then, the one-dimensional coordinate signals are collected into the optical touch-sensing device 600C storing the first firmware 660A, and this optical touch-sensing device 600C processes the one-dimensional coordinate signals to a two-dimensional coordinate signal by the first firmware 660A, and then the two-dimensional coordinate signal is output through the transmission interface 400.

Similarly, a type of the storage devices 650C in the optical touch-sensing devices 600C is not limited by the embodiment. Similar to the embodiment of FIG. 4, the storage device can be fabricated together with the sensor and the signal processor on a single SoC, or can be a one time programming (OTP) device, or similar to the embodiment of FIG. 5, the storage device can be a SRAM in an IC.

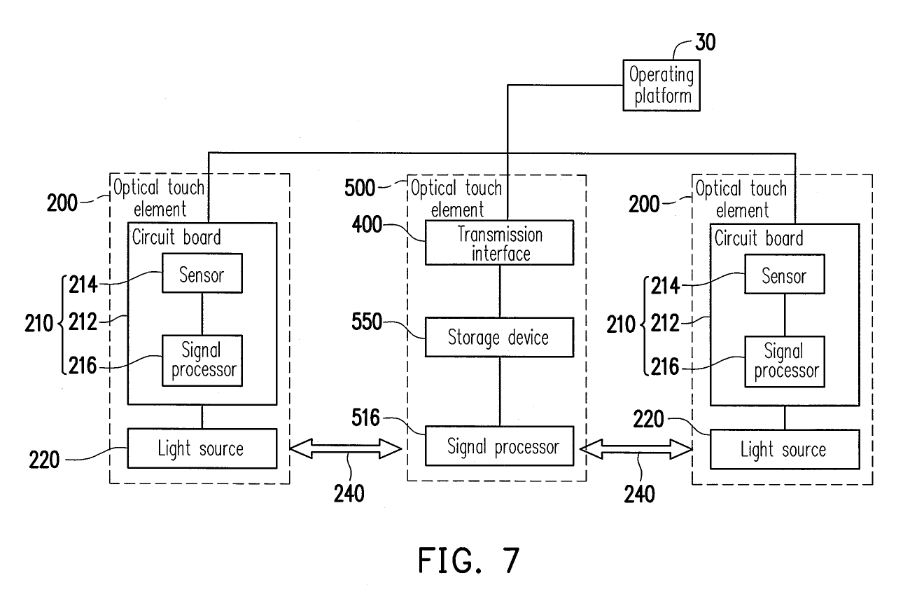

FIG. 7 is a block diagram illustrating an optical touch-sensing display according to another embodiment of the invention. Referring to FIG. 7, different from the aforementioned embodiments, the optical touch-sensing display of the present embodiment further includes a webcam 500 disposed on the display device 100, and the webcam 500 is electrically connected to the optical touch-sensing devices 200 via the SPI circuit 240. Here, structures and functions of the optical touch-sensing devices 200 are the same as that described in the aforementioned embodiments, so that detailed descriptions thereof are not repeated, and a number of the optical touch-sensing devices 200 and allocation positions of the optical touch-sensing devices 200 on the display device 100 are not limited by the present embodiment.

It should be noticed that the webcam 500 includes a signal processor 516, a storage device 550 and the transmission interface 400 electrically connected to each other. When the object 20 enters the sensing space P1, the one-dimensional coordinate signals generated by the optical touch-sensing devices 200 are collected into the storage device 550 of the webcam 500 through the SPI circuit 240, and are processed to a two-dimensional coordinate signal by the signal processor 516, and then the two-dimensional coordinate signal is output to the operating platform 30 through the transmission interface 400. In other words, the webcam 500 of the present embodiment has a function similar to the optical touch-sensing device 600A of the embodiment of FIG. 4, i.e. the present embodiment can achieve the same function of touch-sensing as that of the aforementioned embodiments by using the webcam 500 disposed on the display device 100.

In the present embodiment, the operating platform 30 is, for example, a computer host. However, in other embodiments, the operating platform can also be a mobile phone, a personal digital assistant (PDA), a digital camera or other suitable electronic devices.

Moreover, in another embodiment that is not illustrated, the sensor is, for example, a complementary metal-oxide-semiconductor (CMOS), which is used for capturing an image of the object to generate a signal, and transmitting the signal to an operating platform through a transmission interface, which can also achieve an effect similar to that of the aforementioned embodiments.

In this way, the optical touch-sensing display 10 can transmit the two-dimensional signal to the platform 30 through the transmission interface 400. Therefore it can avoid using conventional signal processor additionally and improve the performance of optical touch-sensing.

In summary, in the optical touch-sensing display of the invention, the light guides are disposed at peripheral of the display surface, so that the light emitted by the light sources may have a good light-emitting quality in the sensing space. Moreover, the one-dimensional coordinate signals generated by the sensing modules are first transmitted to one of the sensing modules for coordinate processing, and then the processed coordinate signal is output from the optical touch-sensing device through the USB. In this way, utilization of additional electronic devices is avoided so as to save a signal transmission time, and the optical touch-sensing display may have higher optical touch efficiency.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An optical touch-sensing display, comprising:
a display device, having a display surface and a sensing space upon the display surface;
at least three light guides, disposed at periphery of the display surface, and each of the light guides having two light incident surfaces opposite to each other and a light-emitting surface between the light incident surfaces;
at least two optical touch-sensing devices, disposed on the display device, and located outside of the sensing space, wherein the optical touch-sensing devices are electrically connected to each other, and each of the optical touch-sensing devices comprising:
a sensing module;
at least one light source for emitting light, the light emitted from the light source passing through the light incident surface and the light-emitting surface of the light guide and then entering the sensing space; and
a transmission interface, electrically connected to the sensing modules, wherein each of the sensing modules senses a light variation induced by at least one object in the sensing space to generate a first signal when the object enters the sensing space, and the first signals are transmitted to one of the sensing modules and are processed to a second signal, and then the second signal is output from the optical touch-sensing device through the transmission interface.

2. The optical touch-sensing display as claimed in claim 1, wherein the display surface has a pair of long sides opposite to each other and a pair of short sides opposite to each other, and the light guides respectively extends along at least one of the pair of long sides and at least one of the pair of short sides.

3. The optical touch-sensing display as claimed in claim 2, wherein the transmission interface is a universal serial bus.

4. The optical touch-sensing display as claimed in claim 1, wherein each of, the sensing modules comprises:
a circuit board;
a sensor mounted on the circuit board, the sensor sensing the light variation in the sensing space to generate a sensing signal; and
a signal processor, mounted on the circuit board and electrically connected to the sensor, the signal processor receiving the sensing signal and determining a position of the object relative to the display surface, so as to generate the first signal, wherein the signal processor processes the first signals to the second signal when the first signals are transmitted to the signal processor of one of the sensing modules.

5. The optical touch-sensing display as claimed in claim 4, wherein each of the optical touch-sensing devices further comprises:
at least one conductive wire, the light source being electrically connected to the circuit board via the conductive wire.

6. The optical touch-sensing display as claimed in claim 4, wherein the circuit board is a flexible circuit board, and the light source is mounted on the flexible circuit board.

7. The optical touch-sensing display as claimed in claim 1, wherein the first signal is a one-dimensional coordinate signal, and the second signal is a two-dimensional coordinate signal.

8. The optical touch-sensing display as claimed in claim 7, wherein a coordinate value of the one-dimensional coordinate signal generated by each of the sensing module is varied with a position of the object relative to each of the sensing modules.

9. An optical touch-sensing display, comprising:
a display device, having a quadrilateral display surface, wherein the quadrilateral display surface has four sides and four corners;
at least three sensing modules, respectively disposed at the corners and electrically connected to each other;
four light guides, respectively disposed at the four sides to define a sensing space, and each of the light guides having two light incident surfaces opposite to each other and a light-emitting surface between the light incident surfaces, wherein the light-emitting surface faces to the sensing space;
a plurality of light sources, for emitting light, the light emitted from the light source passing through the light incident surface and the light-emitting surface of the light guide and then entering the sensing space; and
a universal serial bus, electrically connected to the sensing modules, wherein each of the sensing modules senses a light variation induced by at least one object in the sensing space to generate a first signal when the object enters the sensing space, and the first signals are transmitted to one of the sensing modules and are processed to a second signal, and then the second signal is output from the sensing module through the universal serial bus.

10. The optical touch-sensing display as claimed in claim 9, wherein the optical touch-sensing display comprises four sensing modules respectively located at the four corners of the quadrilateral display surface.

11. The optical touch-sensing display as claimed in claim 9, wherein each of the sensing modules comprises:
a circuit board;
a sensor, mounted on the circuit board, the sensor sensing the light variation in the sensing space to generate a sensing signal; and
a signal processor, mounted on the circuit board and electrically connected to the sensor, the signal processor receiving the sensing signal and determining a position of the object relative to the display surface, so as to generate the first signal, wherein the signal processor processes the first signals to the second signal when the first signals are transmitted to the signal processor of one of the sensing modules.

12. The optical touch-sensing display as claimed in claim 11, wherein each of the sensing modules further comprises:
at least one conductive wire, the light source being electrically connected to the circuit board via the conductive wire.

13. The optical touch-sensing display as claimed in claim 11, wherein the circuit board is a flexible circuit board, and the light source is mounted on the flexible circuit board.

14. The optical touch-sensing display as claimed in claim 9, wherein the first signal is a one-dimensional coordinate signal, and the second signal is a two-dimensional coordinate signal.

15. The optical touch-sensing display as claimed in claim 14, wherein a coordinate value of the one-dimensional coordinate signal generated by each of the sensing module is varied with a position of the object relative to each of the sensing modules.

16. An optical touch-sensing display, comprising:
a display device, having a display surface and a sensing space upon the display surface;
at least three light guides, disposed at periphery of the sensing space, each of the light guides having two ends opposite to each other, at least one light incident surface located at the ends, and a light-emitting surface between the ends, wherein the light-emitting surface faces to the sensing space;
at least two sensors, electrically connected to each other, and respectively disposed at two adjacent corners of the display surface;
at least two light sources, for emitting light, the light emitted from the light sources passing through the light incident surfaces and the light-emitting surfaces of the light guides and then entering the sensing space; and
a transmission interface, electrically connected to the sensors,
wherein each of the sensors captures an image of at least one object in the sensing space to generate a signal, and the signals are transmitted to an operating platform through the transmission interface.

17. The optical touch-sensing display as claimed in claim 16, further comprising a reflector surrounding the light guide.

18. The optical touch-sensing display as claimed in claim 16, wherein each of the light guides has a microstructure for changing an intensity of the light emitted from the light-emitting surface.

19. The optical touch-sensing display as claimed in claim 16, further comprising:
a serial peripheral interface (SPI) circuit, the sensors are connected to each other via the SPI circuit.

20. The optical touch-sensing display as claimed in claim 16, further comprising:
at least one signal processing device, electrically connected to the sensors, wherein an image captured by each of the sensors is transmitted to the signal processing device for generating the signal.

21. The optical touch-sensing display as claimed in claim 20, further comprising:
at least one circuit board, electrically connected to the light sources, wherein the sensors and the signal processing device are mounted on the circuit board.

22. The optical touch-sensing display as claimed in claim 16, wherein the transmission interface is a universal serial bus.

23. An optical touch module, adapted to a display device to enable a touch function of the display device, the display device having a display surface and a sensing space upon the display surface, and the optical touch module comprising:
at least one first optical touch-sensing device, disposed on the display device and located at a corner of the display surface;
at least one second optical touch-sensing device, disposed on the display device and located at another corner of the display surface;
an interface circuit, the first optical touch-sensing device and the second optical touch-sensing device are electrically connected to each other via the interface circuit; and
a transmission interface, electrically connected to at least one of the first optical touch-sensing device and the second optical touch-sensing device, wherein the first optical touch-sensing device and the second optical touch-sensing device sense at least one object and respectively generate a one-dimensional coordinate signal when the object enters the sensing space, the one-dimensional coordinate signals are transmitted to one of the first optical touch-sensing device and the second optical touch-sensing device, and are processed to a two-dimensional coordinate signal, and then the two-dimensional coordinate signal is output from the optical touch module through the transmission interface.

24. The optical touch module as claimed in claim 23, wherein the first optical touch-sensing device comprises a first system chipset and a storage device, the second optical touch-sensing device comprises a second system chipset, the storage device is electrically connected to the first system chipset and the second system chipset, when the object enters the sensing space, the first system chipset and the second system chipset sense the object and respectively generate the one-dimensional coordinate signal, and then the one-dimensional coordinate signals are transmitted to the storage device, and are processed to the two-dimensional coordinate signal through the first system chipset.

25. The optical touch module as claimed in claim 24, further comprising at least one light source suitable for emitting light towards the sensing space, wherein the first system chipset and the second system chipset sense light reflected by the object, and determine a position of the object relative to the display surface, so as to respectively generate the one-dimensional coordinate signal.

26. The optical touch module as claimed in claim 24, wherein the first system chipset and the second system chipset respectively comprise:
a sensor, sensing light reflected by the object to generate a sensing signal; and
a signal processor, electrically connected to the sensor, for receiving the sensing signal and determining a position of the object relative to the display surface, so as to generate the one-dimensional coordinate signal.

27. The optical touch module as claimed in claim 26, wherein the sensor and the signal processor are fabricated on a single system on a chip (SoC).

28. The optical touch module as claimed in claim 24, wherein the storage device is a serial flash memory.

29. The optical touch module as claimed in claim 24, wherein the storage device is a one time programming (OTP) device.

30. The optical touch module as claimed in claim 23, wherein the interface circuit is a serial peripheral interface (SPI) circuit.

31. The optical touch module as claimed in claim 23, wherein the transmission interface is a universal serial bus (USB).

32. The optical touch module as claimed in claim 23, wherein the optical touch module includes a first optical touch-sensing device and a plurality of second optical touch-sensing devices, and the one-dimensional coordinate signals generated by the first optical touch-sensing device and the second optical touch-sensing devices are transmitted to one of the second optical touch-sensing devices.

33. The optical touch module as claimed in claim 32, wherein the one-dimensional coordinate signals generated by the second optical touch-sensing devices are transmitted to one of the second optical touch-sensing devices and are further transmitted to the first optical touch-sensing device.

34. An optical touch-sensing display, comprising:
a display device, having a display surface and a sensing space upon the display surface;
a first optical touch-sensing device, comprising:
a first system chipset;
a storage device; at least one second optical touch-sensing device, comprising:
a second system chipset, electrically connected to the first system chipset; and
a transmission interface, electrically connected to the first optical touch-sensing device, wherein the first optical touch-sensing device and the second optical touch-sensing device sense at least one object and respectively generate a one-dimensional coordinate signal when the object enters the sensing space, the one-dimensional coordinate signals are transmitted to the storage device, and are processed to a two-dimensional coordinate signal by the first system chipset, and then the two-dimensional coordinate signal is output from the first optical touch-sensing device through the transmission interface.

35. The optical touch-sensing display as claimed in claim 34, wherein the first optical touch-sensing device is a webcam comprising the storage device and the transmission interface.

36. The optical touch-sensing display as claimed in claim 34, further comprising a serial peripheral interface circuit, the first optical touch-sensing device and the second optical touch-sensing device are electrically connected to each other via the serial peripheral interface circuit.

37. The optical touch-sensing display as claimed in claim 34, wherein the transmission interface is a universal serial bus.

38. The optical touch-sensing display as claimed in claim 34, further comprising at least one light source suitable for emitting light towards the sensing space, wherein the first system chipset and the second system chipset sense light reflected by the object, and determine a position of the object relative to the display surface, so as to respectively generate the one-dimensional coordinate signal.

39. The optical touch-sensing display as claimed in claim 34, wherein the first system chipset and the second system chipset respectively comprise:
a sensor, sensing light reflected by the object to generate a sensing signal; and
a signal processor, electrically connected to the sensor, for receiving the sensing signal and determining a position of the object relative to the display surface, so as to generate the one-dimensional coordinate signal.

40. The optical touch-sensing display as claimed in claim 39, wherein the storage device, the sensor and the signal processor are fabricated on a single system on a chip (SoC).

41. The optical touch-sensing display as claimed in claim 39, wherein the signal processor of the first system chipset is an integrated circuit (IC), and the storage device is a static random access memory (SRAM) in the integrated circuit.

42. The optical touch-sensing display as claimed in claim 34, wherein the storage device is a one time programming (OTP) device.

43. The optical touch-sensing display as claimed in claim 34, wherein the storage device is a serial flash memory.

44. An optical touch-sensing display, comprising:
a display device, having a display surface and a sensing space upon the display surface;
a webcam, disposed on the display device and located outside of the display surface, and comprising a first storage device and a universal serial bus electrically connected to the first storage device; and
at least two optical touch-sensing devices, disposed on the display device and located outside of the display surface, and electrically connected to the webcam, wherein each of the optical touch-sensing devices comprising:
a system chipset; and
a second storage device, electrically connected to the system chipset,
wherein the optical touch-sensing devices sense at least one object and respectively generate a first signal when the object enters the sensing space, then the first signals are transmitted to one of the first storage device and the second storage devices, and are processed to a second signal, and then the second signal is output from the webcam through the universal serial bus.
